(19) United States
(12) Patent Application Publication
(10) Pub. No.: US 2022/0259379 A1
(43) Pub. Date: Aug. 18, 2022

(54) COPOLYAMIDES OBTAINABLE FROM 4-(AMINOMETHYL)BENZOIC ACID

(71) Applicant: SOLVAY SPECIALTY POLYMERS USA, LLC, Alpharetta, GA (US)

(72) Inventors: Stéphane JEOL, Saint-Genis-Laval (FR); Nancy J. SINGLETARY, Alpharetta, GA (US); Joel FLORES, Alpharetta, GA (US); Joel POLLINO, Johns Creek, GA (US)

(21) Appl. No.: 17/604,828

(22) PCT Filed: Apr. 21, 2020
(86) PCT No.: PCT/EP2020/061102

§ 371 Date: Oct. 19, 2021

Related U.S. Application Data
(60) Provisional application No. 62/836,965, filed on Apr. 22, 2019.

(30) Foreign Application Priority Data
Jun. 21, 2019 (EP) 19181767.5

(51) Int. Cl. C08G 69/26

(52) U.S. Cl. CPC C08G 69/26

(57) ABSTRACT

The present invention relates to copolyamides comprising 4-(aminomethyl)benzoic acid (4-AMBa). The present invention also relates to polymer compositions comprising such copolyamides, as well as articles comprising the same and methods of using said articles to prepare windows, clear containers for cosmetic products packaging or glass frames & lenses. The present invention also relates to the use of the copolyamide, as such or in a composition of matter, for the manufacture of three-dimensional objects using an additive manufacturing system, for example an extrusion-based manufacturing system.

### RELATED APPLICATIONS

This application claims priority to U.S. provisional application No. 62/836,965, filed on Apr. 22, 2019 and to European patent application No 19181767.5 filed on Jun. 21, 2019, the whole content of each of these applications being incorporated herein by reference for all purposes.

### TECHNICAL FIELD

The present invention relates to copolyamides comprising at least from 5 mol. % to 90 mol. % of 4-(aminomethyl)benzoic acid (4-AMBa). The present invention also relates to polymer compositions comprising such copolyamides, as well as articles comprising the same and methods of using said articles to prepare transparent or semi-transparent articles.

### BACKGROUND ART

In the polymer industry, attention is nowadays being paid to reduce the environmental footprint. One way to proceed is to identify biologic sources and define processes for converting these materials into valuable monomers, which are then converted into bio-based polymers.

While most polyamides are based on fossil resources, some bio-based polyamides are known and commercially available. Reference can notably be made to polyamide 11 (PA 11), produced by polymerization of 11-aminoundecanoic acid, derived from castor oil; polyamide 1010 (PA 1010), produced by polymerization of decamethylene diamine and sebacid acid, both derived from castor oil; polyamide 10T (PA 10T), produced by polymerization of decamethylene diamine and terephthalic acid (fossil based) and thus partly based on renewable raw monomers.

Most of the commercially available biobased polyamides have a low glass transition temperature (Tg) which make them unsuitable in applications requiring a high temperature resistance. PA11, commercially available under the trade name Rislan® (Arkema) has a Tg around 45° C. All of the bio-based polyamides commercially available under the trade name Vestamid® (Evonik), for example Vestamid® Terra DS (PA1010), have a Tg lower than 50° C.

As described in WO 2018/229127 (Solvay), the use 3-(aminomethyl)benzoic acid (3-AMBa), which can be synthesized from furfural (bio), leads to such polyamides. These polyamides can be either semi-crystalline or amorphous. The amorphous polyamide deriving from 3-AMBa has indeed been shown to present a high Tg and a high modulus. The polyamides derived from this bio-sourced monomer are very-well suited for applications requiring a high temperature resistance, as for example for automotive applications.

There is today a need for biobased, high Tg, high performance polyamides. Especially there is a need for such polyamides for optical applications in which the articles are transparent or semi-transparent, like plastic windows, clear containers for cosmetic products packaging, glass frames and lenses.

The inventors have now identified that polyamides based on specific molar ratio of 4-(aminomethyl)benzoic acid (4-AMBa) present a high Tg and high performances and can be obtained from a renewable source such as 5-chloromethylfurfural.

U.S. Pat. No. 3,037,002 describes polyamides obtained from 4-AMBa and caprolactam. These polyamides however co-crystallize due to isomorphism between caprolactam and 4-AMBa, which prevent from making amorphous polymers.

Other polyamides incorporating 4-AMBa have been disclosed, but all these polyamides are semi-crystalline as they present a melting point (Tm).

### DISCLOSURE OF THE INVENTION

The copolyamide of the present invention has the following formula (I):

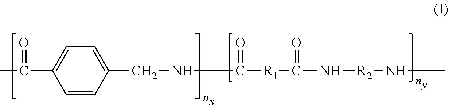

wherein:
nₓ and n_{y} are respectively the moles % of each recurring units x and y; recurring units x and y are arranged in blocks, in alternation or randomly;
nₓ+n_{y}=100%;
5%<nₓ<90%;
R₁ is selected from the group consisting of a bond, a C₁-C₁₅ alkyl and a C₆-C₃₀ aryl, optionally comprising one or more heteroatoms (e.g. O, N or S) and optionally substituted with one or more substituents selected from the group consisting of halogen (e.g. fluorine, chlorine, bromine or iodine), hydroxy (—OH), sulfo (—SO₃M) (e.g. wherein M is H, Na, K, Li, Ag, Zn, Mg or Ca), C₁-C₆ alkoxy, C₁-C₆ alkylthio, C₁-C₆ acyl, formyl, cyano, C₆-C₁₅ aryloxy and C₆-C₁₅ aryl; and
R² is selected from the group consisting of a C₁-C₂₀ alkyl and a C₆-C₃₀ aryl, optionally comprising one or more heteroatoms (e.g. O, N or S) and optionally substituted with one or more substituents selected from the group consisting of halogen (e.g. fluorine, chlorine, bromine or iodine), hydroxy (—OH), sulfo (—SO₃M) (e.g. wherein M is H, Na, K, Li, Ag, Zn, Mg or Ca), C₁-C₆ alkoxy, C₁-C₆ alkylthio, C₁-C₆ acyl, formyl, cyano, C₆-C₁₅ aryloxy and C₆-C₁₅ aryl.

The expression “copolyamide” is hereby used for designating copolyamides comprising 5 mol. % or more of recurring units x, for example derived from 4-(aminomethyl)benzoic acid (4-AMBa). The copolyamide of the present invention may for example comprise at least about 5 mol. % of recurring units x, for example derived from 4-(aminomethyl)benzoic acid (4-AMBa), for example at least about 10 mol. %, at least about 15 mol. %, at least about 20 mol. %, at least about 25 mol. %, at least about 30 mol. %, at least about 35 mol. %, at least about 40 mol. %, at least about 45 mol. %, at least about 50 mol. %, at least about 55 mol. %, at least about 60 mol. %, at least about 65 mol. %, at least about 70 mol. %, at least about 75 mol. %, at least about 80 mol. % or at least about 85 mol. %.

The copolyamides of the present invention may have a number average molecular weight Mn ranging from 1,000 g/mol to 40,000 g/mol, for example from 2,000 g/mol to 35,000 g/mol or from 4,000 to 30,000 g/mol. The number average molecular weight Mn can be determined by gel permeation chromatography (GPC) using ASTM D5296 with polystyrene standards.

In the copolyamide of the present invention, the recurring unity may be aliphatic or aromatic. For the purpose of the present invention, the expression “aromatic recurring unit” is intended to denote any recurring unit that comprises at least one aromatic group. The aromatic recurring units may be formed by the polycondensation of at least one aromatic dicarboxylic acid with an aliphatic diamine or by the polycondensation of at least one aliphatic dicarboxylic acid with an aromatic diamine or by the polycondensation of at least one aromatic dicarboxylic acid with an aromatic diamine. For the purpose of the present invention, a dicarboxylic acid or a diamine is considered as “aromatic” when it comprises one or more than one aromatic group.

The copolyamide of the present invention is composed of recurring units x and y. Recurring units x and y are arranged in blocks, in alternation or randomly.

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

Throughout this document, all temperatures are given in degrees Celsius (° C.).

Unless specifically limited otherwise, the term “alkyl”, as well as derivative terms such as “alkoxy”, “acyl” and “alkylthio”, as used herein, include within their scope straight chain, branched chain and cyclic moieties. Examples of alkyl groups are methyl, ethyl, 1-methylethyl, propyl, 1,1-dimethylethyl, and cyclo-propyl. Unless specifically stated otherwise, each alkyl and aryl group may be unsubstituted or substituted with one or more substituents selected from but not limited to halogen, hydroxy, sulfo, C₁-C₆ alkoxy, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied. The term “halogen” or “halo” includes fluorine, chlorine, bromine and iodine, with fluorine being preferred.

The term “aryl” refers to a phenyl, indanyl or naphthyl group. The aryl group may comprise one or more alkyl groups, and are called sometimes in this case “alkylaryl”; for example may be composed of a cycloaromatic group and two C₁-C₆ groups (e.g. methyl or ethyl). The aryl group may also comprise one or more heteroatoms, e.g. N, O or S, and are called sometimes in this case “heteroaryl” group; these heteroaromatic rings may be fused to other aromatic systems. Such heteroaromatic rings include, but are not limited to furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures. The aryl or heteroaryl substituents may be unsubstituted or substituted with one or more substituents selected from but not limited to halogen, hydroxy, C₁-C₆ alkoxy, sulfo, C₁-C₆ alkylthio, C₁-C₆ acyl, formyl, cyano, C₆-C₁₅ aryloxy or C₆-C₁₅ aryl, provided that the substituents are sterically compatible and the rules of chemical bonding and strain energy are satisfied.

According to an embodiment, the copolyamide of the present invention is the condensation product of a mixture comprising from 5 mol. % to 90 mol.% of 4-(aminomethyl)benzoic acid (4-AMBa) monomers or derivative thereof, as well as at least one dicarboxylic acid component (also called hereby diacid) or derivative thereof, and at least one diamine component.

The expression “at least” is hereby intended to denote “equals to or more than”. For example, the expression “at least 5 mol. % of 4-AMBa monomers” hereby denotes that the copolyamide may comprise 5 mol. % of 4-AMBa monomers or more than 5 mol. % of 4-AMBa monomers. The expression “at least” therefore corresponds to the mathematical symbol “≥” in the context of the present invention.

The expression “less than” corresponds to the mathematical symbol “<” in the context of the present invention. For example, the expression “less than 90 mol. % of 4-AMBa monomers” hereby denotes that the copolyamide comprises strictly less than 90 mol. % of 4-AMBa monomers and therefore qualify as a copolyamide, made from 4-AMBa monomers and at least one another monomer or diamine/diacid combination.

The expression “derivative thereof” when used in combination with the expression “4-AMBa monomer” is intended to denote whichever derivative which is susceptible of reacting in polycondensation conditions to yield an amide bond. Examples of amide-forming derivatives include acyl groups, for example aliphatic acyl and aromatic acyl groups, substituted or unsubstituted. Examples of these acyl groups are formyl, acetyl, propionyl, butyryl, isobutyryl, valeryl, isovaleryl, pivaloyl, benzoyl, toluoyl and xyloyl.

According to this embodiment, the dicarboxylic acid component can be chosen among a large variety of aliphatic or aromatic components comprising at least two acidic moieties —COOH. According to this embodiment, the diamine component can be chosen among a large variety of aliphatic or aromatic components comprising at least two amine moieties —NH₂.

The expression “derivative thereof” when used in combination with the expression “dicarboxylic acid” is intended to denote whichever derivative which is susceptible of reacting in polycondensation conditions to yield an amide bond. Examples of amide-forming derivatives include a mono- or di-alkyl ester, such as a mono- or di-methyl, ethyl or propyl ester, of such carboxylic acid; a mono- or di-aryl ester thereof; a mono- or di-acid halide thereof; a carboxylic anhydride thereof and a mono-or di-acid amide thereof, a mono- or di-carboxylate salt.

Non limitative examples of aliphatic dicarboxylic acids are notably oxalic acid (HOOC—COOH), malonic acid (HOOC—CH₂—COOH), succinic acid [HCOO—(CH₂)₂—COOH], glutaric acid [HCOO—(CH₂)₃—COOH], 2,2-dimethyl-glutaric acid [HOOC—C(CH₃)₂—(CH₂)₂—COOH], adipic acid [HCOO—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HCOO—(CH₂)₆—COOH], azelaic acid [HCOO—(CH₂)₇—COOH], sebacic acid [HCOO—(CH₂)8—COOH], undecanedioic acid [HCOO—(CH₂)₉—COOH], dodecandioic acid [HCOO—(CH₂)₁₀—COOH], tridecanedioic acid [HCOO—(CH₂)₁₁—COOH], tetradecanedioic acid [HCOO—(CH₂)₁₂—COOH], pentadecanedioic acid [HCOO—(CH₂)13—COOH], hexadecanedioic acid [HCOO—(CH₂)₁₄—COOH], octadecanedioic acid [HCOO—(CH₂)₁₆—COOH]. Included in this category are also cycloalphatic dicarboxylic acid such as 1,4-cyclohexane dicarboxylic acid.

Non limitative examples of aromatic diacids are notably phthalic acids, including isophthalic acid (IPA), terephthalic acid (TPA), naphthalenedicarboxylic acids (e.g. naphthalene-2,6-dicarboxylic acid), 4,4′-bibenzoic acid, 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene.

Non limitative examples of aromatic diamines (NNₐᵣ) are notably m-phenylene diamine (MPD), p-phenylene diamine (PPD), 3,4′-diaminodiphenyl ether (3,4′-ODA), 4,4′-diaminodiphenyl ether (4,4′-ODA), p-xylylene diamine (PXDA) and m-xylylenediamine (MXDA).

Non limitative examples of aliphatic diamines (NNₐₗ) are notably 1,2-diaminoethane, 1,2-diaminopropane, propylene-1,3-diamine, 1,3-diaminobutane, 1,4-diaminobutane (putrescine), 1,5-diaminopentane (cadaverine), 2-methyl-1,5-diaminopentane, hexamethylenediamine (or 1,6-diaminohexane), 3-methylhexamethylenediamine, 2,5-dimethylhexamethylenediamine, 2,2,4-trimethyl-hexamethylenediamine, 2,4,4-trimethyl-hexamethylenediamine, 1,7-diaminoheptane, 1,8-diaminooctane, 2,2,7,7-tetramethyloctamethylenediamine, 1,9-diaminononane, 2-methyl-1,8-diaminooctane, 5-methyl-1,9-diaminononane, 1,10-diaminodecane, 1,11-diaminoundecane, 1,12 diaminododecane, 1,13 diaminotridecane, 2,5-diamonotetrahydrofurane and N,N-Bis(3-aminopropyl)methylamine. Included in this category are also cycloaliphatic diamine such as isophorone diamine, 1,4-diaminocyclohexane, 1,3-diaminocyclohexane, 1,3-diaminocyclohexane, 1,4-diaminocyclohexane, bis-p-aminocyclohexylmethane, 1,3-bis(aminomethyl)cyclohexane and 1,4-bis(aminomethyl)cyclohexane, 4,4′-methylenebis(cyclohexylamine), 4,4′-methylenebis(2-methylcyclohexylamine).

The aliphatic diamines (NNal) can also be selected in the group of polyetherdiamines. The polyetherdiamines can be based on an ethoxylated (EO) backbone and/or on a propoxylated (PO) backbone and they can be ethylene-oxide terminated, propylene-oxide terminated or butylene-oxide terminated diamines. Such polyetherdiamines are for example sold under the trade name Jeffamine® and Elastamine® (Hunstman).

According to an embodiment, the copolyamide is the condensation product of a mixture comprising:
from 5 mol. % to 90 mol. % of 4-(aminomethyl)benzoic acid (4-AMBa) monomers (recurring unit x) or derivative thereof,
at least one dicarboxylic acid component and
at least one diamine component,
   wherein:
the dicarboxylic acid component is selected from the group consisting of adipic acid, azelaic acid, sebacic acid, dodecanedioic, isophthalic acid, terephthalic acid, 2,6-naphthalene dicarboxylic acid, 4,4′-bibenzoic acid, 5-hydroxyisophthalic acid, 5-sulfophthalic acid, and mixture thereof, and
the diamine component is selected from the group consisting of 1,4-diaminobutane, 1,5-diamonopentane, 2-methyl-1,5diaminopentane, hexamethylenediamine, 1,9-diaminononane, 2-methyl-1,8-diaminooctoane, 1,10-diaminedecane, 1,3-bis(aminomethyl)cyclohexane H₂N—(CH₂)₃—O—(CH₂)₂—O(CH₂)₃—NH₂, m-xylylene diamine, p-xylylene and mixture thereof.

According to another embodiment, the copolyamide is the condensation product of a mixture comprising :
from 5 mol. % to 90 mol. % of 4-(aminomethyl)benzoic acid (4-AMBa) monomers (recurring unit x) or derivative thereof,
at least one dicarboxylic acid component and
at least one diamine component,
   wherein:
the dicarboxylic acid component is selected from the group consisting of adipic acid, sebacid acid, terephthalic acid, isopthalic acid and mixture thereof, and
the diamine component is selected from the group consisting of hexamethylenediamine, m-xylylene diamine, 1,10-decamethylene diamine, 1,3-bis(aminomethyl)cyclohexane and mixture thereof.

The copolyamide of the present invention comprises at least 5 mol. % of 4-(aminomethyl)benzoic acid (4-AMBa) monomers or derivative thereof.

According to another preferred embodiment, the copolyamide comprises at least 50 mol. % of 4-(aminomethyl)benzoic acid (4-AMBa) monomers or derivative thereof, for example at least 60 mol. %, at least 70 mol. %, at least 75 mol. % of 4-AMBa or derivative thereof. According to this embodiment, the copolyamide is such that:
50%<nₓ<90%,
60%<nₓ<90%,
70%<nₓ<90% or
75%<nₓ<90%.

The copolyamide of the present invention comprises less than 90 mol. %

of 4-(aminomethyl)benzoic acid (4-AMBa) monomers or derivative thereof.

According to another preferred embodiment, the copolyamide comprises less than 89 mol. % of 4-(aminomethyl)benzoic acid (4-AMBa) monomers or derivative thereof, for example less than 88 mol. %, less than 87 mol. %, less than 86 mol. % of 3-AMBa. According to this embodiment, the copolyamide is such that:
5%<nₓ<89%,
5%<nₓ<88%,
5%<nₓ<87% or
5%<nₓ<86%.

According to another preferred embodiment, the copolyamide comprises less than 85 mol. % of 4-(aminomethyl)benzoic acid (4-AMBa) monomers or derivative thereof, for example less than 80 mol. %, less than 75 mol. %, less than 71 mol. % of 3-AMBa. According to this embodiment, the copolyamide can be such that :
5%<nₓ<85%,
25%<nₓ<80%,
45%<nₓ<75% or
50%<nₓ<71%.

nₓ and n_{y} are respectively the moles % of each recurring units x and y. As an example of the different embodiments of the present invention, if the copolyamide of the present invention is composed exclusively of recurring units x and y, then nₓ+n_{y}=100%. In this case, the recurring unity is composed of a diamine component and a diacid component; the number of moles of diamines and the number of moles of diacids to be added to the condensation reaction are equal. For example, if the copolyamide is composed exclusively of 4-AMBa, as well as terephthalic acid and hexamethylenediame, with nₓ=60 mol. % and n_{y}=40 mol. %, then substantially the same number of moles of terephtalic acid and hexamethylenediamine should be added to the condensation mixture, that is to say 40 mol. %. The term “substantially” is hereby intended to denote that the ratio diacid/diamine varies between 0.9 to 1.1, for example between 0.95 and 1.05. According to an embodiment of the present invention, the copolyamide is amorphous, that-is-to-say that the copolyamide does not show any thermal transition other than the glass transition temperature, as measured by Differential Scanning calorimetry at a heating rate of 10-20° C./g.

According to an embodiment, the copolyamide of the present invention has a glass transition temperature of at least about 100° C., as determined according to ASTM D3418. According to this embodiment, the copolyamide of the present invention may have for example a melting point of at least about 105° C., at least about 110° C. or at least about 120° C.

According to another embodiment of the present invention, the copolyamide is amorphous and is the condensation product of a mixture comprising less than 90 mol. % of 4-(aminomethyl)benzoic acid (4-AMBa), and at least one dicarboxylic acid component or derivative thereof, and at least one diamine component.

According to another embodiment of the present invention, the copolyamide is amorphous and is the condensation product of a mixture comprising more than 60 mol % and less than 80 mol. % of 4-(aminomethyl)benzoic acid (4-AMBa), and at least one dicarboxylic acid component or derivative thereof, and at least one diamine component.

The copolyamide of the present invention can be prepared by any conventional method adapted to the synthesis of polyamides and polyphthalamides, for example by thermal polycondensation of aqueous solution of monomers and comonomers. The copolyamides may contain a chain limiter, which is a monofunctional molecule capable of reacting with the amine or carboxylic acid moiety, and is used to control the molecular weight of the copolyamide. For example, the chain limiter can be acetic acid, propionic acid and/or benzylamine. A catalyst can also be used. Examples of catalyst are phosphorous acid, ortho-phosphoric acid, meta-phosphoric acid, alkali-metal hypophosphite such as sodium hypophosphite and phenylphosphinic acid.

### Polyamide Composition (C)

The polyamide composition (C) comprises the copolyamides of the present invention, above described.

The copolyamides may be present in the composition (C) in a total amount of greater than 30 wt. %, greater than 35 wt. % by weight, greater than 40 wt. % or greater than 45 wt. %, based on the total weight of the polymer composition (C).

The copolyamides may be present in the composition (C) in a total amount of less than 99.5 wt. %, less than 99 wt.%, less than 95 wt. %, less than 90 wt. %, less than 80 wt. % or less than 70 wt. %, based on the total weight of the polymer composition (C).

The copolyamides may for example be present in the composition (C) in an amount ranging between 35 and 60 wt. %, for example between 40 and 55 wt. %, based on the total weight of the polyamide composition (C).

The composition (C) may also comprise one component selected from the group consisting of reinforcing agents, tougheners, plasticizers, colorants, pigments, antistatic agents, dyes, lubricants, thermal stabilizers, light stabilizers, flame retardants, nucleating agents and antioxidants.

A large selection of reinforcing agents, also called reinforcing fibers or fillers, may be added to the composition according to the present invention. They can be selected from fibrous and particulate reinforcing agents. A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50.

The reinforcing filler may be selected from mineral fillers (such as talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers and wollastonite.

Among fibrous fillers, glass fibers are preferred; they include chopped strand A-, E-, C-, D-, S- and R-glass fibers, as described in chapter 5.2.3, p. 43-48 of Additives for Plastics Handbook, 2nd edition, John Murphy. Preferably, the filler is chosen from fibrous fillers. It is more preferably a reinforcing fiber that is able to withstand the high temperature applications.

The reinforcing agents may be present in the composition (C) in a total amount of greater than 15 wt. %, greater than 20 wt. % by weight, greater than 25 wt. % or greater than 30 wt. %, based on the total weight of the polymer composition (C). The reinforcing agents may be present in the composition (C) in a total amount of less than 65 wt. %, less than 60 wt. %, less than 55 wt. % or less than 50 wt. %, based on the total weight of the polymer composition (C).

The reinforcing filler may for example be present in the composition (C) in an amount ranging between 20 and 60 wt. %, for example between 30 and 50 wt. %, based on the total weight of the polyamide composition (C).

The composition (C) of the present invention may also comprise a toughener. A toughener is generally a low glass transition temperature (T_{g}) polymer, with a T_{g} for example below room temperature, below 0° C. or even below −25° C. As a result of its low T_{g}, the toughener are typically elastomeric at room temperature. Tougheners can be functionalized polymer backbones.

The polymer backbone of the toughener can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

The toughener may be present in the composition (C) in a total amount of greater than 1 wt. %, greater than 2 wt. % or greater than 3 wt. %, based on the total weight of the composition (C). The toughener may be present in the composition (C) in a total amount of less than 30 wt. %, less than 20 wt. %, less than 15 wt. % or less than 10 wt. %, based on the total weight of the polymer composition (C).

The composition (C) may also comprise other conventional additives commonly used in the art, including plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants, nucleating agents and antioxidants.

The composition (C) may also comprise one or more other polymers, preferably polyamides different from the copolyamide of the present invention. Mention can be made notably of semi-crystalline or amorphous polyamides, such as aliphatic polyamides, semi-aromatic polyamides, and more generally the polyamides obtained by polycondensation between an aromatic or aliphatic saturated diacid and an aliphatic saturated or aromatic primary diamine, a lactam, an amino-acid or a mixture of these different monomers.

### Preparation of the Polyamide Composition (C)

The invention further pertains to a method of making the composition (C) as above detailed, said method comprising melt-blending the copolyamide and the specific components, e.g. a filler, a toughener, a stabilizer, and of any other optional additives.

Any melt-blending method may be used for mixing polymeric ingredients and non-polymeric ingredients in the context of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. If a reinforcing agent presents a long physical shape (for example, a long glass fiber), drawing extrusion molding may be used to prepare a reinforced composition.

### Articles and Applications

The present invention also relates to articles comprising the copolyamide described above and to articles comprising the copolyamide composition (C) described above.

The article can notably be used in automotive applications, for example in air induction systems, cooling and heating systems, drivetrain systems and fuel systems. The article can also be used in LED packaging, mobile electronics, oil and gas applications, plumbing, optical applications like plastic windows, clear containers for cosmetic products packaging, glass frames & lenses. Examples of electric and electronics devices are connectors, contactors and switches. The copolyamide may also be used as a gas barrier material for packaging applications, in mono or multilayer articles.

The article can be molded from the copolyamide or copolyamide composition (C) of the present invention, by any process adapted to thermoplastics, e.g. extrusion, injection molding, blow molding, rotomolding or compression molding.

The article can be printed from the copolyamide or copolyamide composition (C) of the present invention, by a process comprising a step of extrusion of the material, which is for example in the form of a filament, or comprising a step of laser sintering of the material, which is in this case in the form of a powder.

The present invention also relates to a method for manufacturing a three-dimensional (3D) object with an additive manufacturing system, comprising:
providing a part material comprising the copolyamide or copolyamide composition (C) of the present invention, and
printing layers of the three-dimensional object from the part material.

The copolyamide or copolyamide composition (C) can therefore be in the form of a thread or a filament to be used in a process of 3D printing, e.g. Fused Filament Fabrication, also known as Fused Deposition Modelling (FDM).

The copolyamide or copolyamide composition (C) can also be in the form of a powder, for example a substantially spherical powder, to be used in a process of 3D printing, e.g. Selective Laser Sintering (SLS).

### Use of the Copolyamides, Composition (C) and Articles

The present invention relates to the use of the above-described copolyamides, composition (C) or articles in air induction systems, cooling and heating systems, drivetrain systems and fuel systems or in in mobile electronics, for example in a mobile electronic device., optical applications like plastic windows, clear containers for cosmetic products packaging, glass frames & lenses.

The present invention also relates to the use of the above-described copolyamides or composition (C) for 3D printing an object.

Should the disclosure of any patents, patent applications, and publications which are incorporated herein by reference conflict with the description of the present application to the extent that it may render a term unclear, the present description shall take precedence.

### EXAMPLES

### Raw Materials

4-AMBa : 4-(aminomethyl)benzoic acid monomer (Sigma-Aldrich)

3-AMBa : 3-(aminomethyl)benzoic acid monomers, obtained by the process described in patent application WO 2017/097220, from biobased furfural derivatives (5 carbon atoms over 8 carbon atoms are from biobased sources).

Isophthalic acid (Flint Hills Resources)

Hexamethylenediamine (Ascend Performance Materials)

1,3-bis(aminomethyl)cyclohexane (Mitsubishi Gas Company)

### Copolyamides Preparation

Synthesis of Ex 1 and 2: The molar equivalent amounts of 1,4-AMBA, hexamethylenediamine and isophthalic (Table 1) acid were charged into the agitated reactor and added with DI water (30 wt %). Phosphorous acid (120 ppm equivalent P) was used as an additive in the polymerization. The mixture was agitated and heated to 310° C. The steam generated was released and the reacting mixture was further heated at this temperature for another 60 minutes at ambient pressure. Vacuum was applied for 10 minutes before the heating was turned off. The formed polymer was discharged and analyzed for its thermal properties.

Synthesis of Ex 3: The molar equivalent amounts of 1,4-AMBA, 1,3-bis(aminomethyl)cyclohexane and isophthalic acid (Table 1) were charged into the agitated reactor and added with DI water (30 wt %). Phosphorous acid (120 ppm equivalent P) was used as an additive in the polymerization. The mixture was agitated and heated to 310° C. The steam generated was released and the reacting mixture was further heated at this temperature for another 60 minutes at ambient pressure. Vacuum was applied for 10 minutes before the heating was turned off. The formed polymer was discharged and analyzed for its thermal properties.

Synthesis of Ex 4: The polymerization was conducted using a jacketed 300-ml reactor equipped with a distillation line, a pressure regulation valve, an agitator and a discharge valve. The vessel was charged with 61.00 g 1,4-AMBA, 31.57 g HMD, 44.69 g isophthalic acid, 0.047 g sodium acetate, 0.123 g NaH2PO2.H2O and 59 g deionized water. The reactor was purged 3 times with nitrogen (5 bars) and sealed under a nitrogen atmosphere. The regulation valve was set at 17.5 bars and the reaction mixture was heated to 220° C. in about 50 minutes under stirring. The reaction mixture was further heated up to 280° C. during an additional 70 minutes, while the regulation valve maintained a plateau pressure of 17.5 bars. The pressure was then reduced down to 2 bars in about 25 minutes. The polymer was then discharged from the reactor, drawn, cooled in a water bath and pelletized.

Synthesis of Ex 5: The polymerization was performed using a jacketed 7.5 L autoclave reactor equipped with a distillation line, a pressure regulation valve and an agitator. The vessel was charged with 1193 g of 1,4-AMBA, 598.6 g of HMD, 856.6 g of isophthalic acid, 0.9119 g sodium acetate, 2.356 g NaH2PO2.H20 and 1140 g deionized water. The polymerization steps described for Ex 3 were followed with the exception of the reactor pressure at discharge. Three identical charges were polymerized with slightly varying discharge pressures of 3.5, 2.7 and 2.5 bars. The combined product was dried to a moisture content of 1550 ppm. The polymer was processed through twin screw extrusion using a Leistritz 18 mm extruder in order to increase molecular weight. Zone temperatures from the hopper to the die were 220, 290, 290, 290, 290 and 300° C. A vacuum of 26 inches of Hg was applied at zone 5. Polymer Ex 4 was produced at a screw speed of 120 rpm and a throughput rate of 3.3 lb/hr. Ex 5 and pre-polymer molecular weight data are reported in Table 2.

Synthesis of CEx 6. The molar equivalent amounts of 1,3-AMBA, hexamethylenediamine and isophthalic acid were charged into the agitated reactor and added with DI water (30 wt %). Phosphorous acid (120 ppm equivalent P) was used as an additive in the polymerization. The mixture was agitated and heated to 300° C. The steam generated was released and the reacting mixture was further heated at this temperature for another 30 minutes and then the reaction was stopped.

### Testing

### Thermal Transitions (Tg, Tm)

The glass transition and melting temperatures were measured using differential scanning calorimetry according to ASTM D3418 employing a heating and cooling rate of 20° C/min. Three scans were used for each DSC test: a first heat up to 320° C., followed by a first cool down to 50° C., followed by a second heat up to 340° C. The Tg was determined from the second heat up. The glass transition temperatures are tabulated in Table 1 (invention) below.

TABLE 1
mol. %

| | Ex 1 | Ex 2 | Ex 3 | Ex 4 | Ex 5 |
|---|---|---|---|---|---|
| 4-AMBa | 50 | 70 | 50 | 60 | 60 |
| Isophthalic acid | 50 | 30 | 50 | 40 | 40 |
| Hexamethylenediamine | 50 | 30 | | 40 | 40 |
| 1,3-BAC | | | 50 | | |
| Tg (° C.) | 156 | 179 | 198 | 165 | 165 |
| Tm (° C.) | — | — | — | — | — |

In comparison to compositions described in WO2018/229127, the copolyamides with 1,4-AMBA surprisingly exhibit higher Tg.

Gel permeation chromatography (GPC) was performed on the copolymer of Example 5 employing a WatersModular SEC Instrument, a Waters Alliance 2695 Separation Module, a Waters 2487 Dual Absorbance Detector, a Waters 2414 Refractive Index Detector, a Waters 515 pump and Waters Empower Pro Gel Chromatography Software. The instrument was equipped with two PL gel 10 μm MiniMixe B 250×4.6 mm columns and a guard column The samples were dissolved at 5 to 6 g/L in HFIP containing 0.05 M NaFTA; a sample was injected. Elution was conducted as 40° C. Results were calibrated against a standard having a Mw=27943, Mn=9340, Mw/Mn=2.99. Molecular weight data for inventive copolymer 5 are presented in Table 2.

TABLE 2

| | Ex 5 | Ex 5 | Ex 5 | |
|---|---|---|---|---|
| | PreP1 | PreP2 | PreP3 | Ex 5 |
| Mₙ | 7.6 | 7.7 | 9.6 | 11.8 |
| M_{w} | 18.8 | 20.3 | 30.8 | 56 |

### Molding and Mechanical Testing

Molding of copolymer of example 4 was accomplished using a DSM Xplore® Microcompounder and Mini Injection System. Applied temperatures were as follows: barrels at 320° C., melt and wand at 300° C., mold at 130° C. The residence time in the microcompounder was 90 s. Fill, pack and hold times and pressures were 9 s at 6 bar, 1.5 s at 4 bar and 8 s at 4 bar, respectively. ASTM Type V tensile bars were evaluated according to ASTM method D638 using a testing speed of 0.05″/min. The mechanical data for Ex 4 are presented in Table 3.

TABLE 3

| | Ex 4 | |
|---|---|---|
| Modulus of Elasticity, GPa (ksi) | 3.23 | (469) |
| Tensile Elongation @ Break (%) | 9.7 | |
| Tensile Elongation @ Yield (%) | 6.7 | |
| Tensile Strength @ Yield, MPa (psi) | 105 | (15,200) |

In addition to the unexpected high Tg, the copolymers of the invention can be polymerized to molecular weights required for good mechanical properties. The copolymers display useful mechanical properties such as ductility and high tensile strength.

1. A copolyamide, having the following formula (I) : 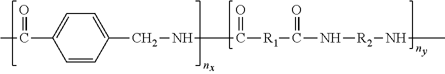
wherein:
nₓ and n_{y} are respectively the moles % of each recurring units x and y ;
recurring units x and y are arranged in blocks, in alternation or randomly;
nₓ+n_{y}=100%;
5%<nₓ<90%;
R₁ is selected from the group consisting of a bond, a C₁-C₁₅ alkyl and a C₆-C₃₀ aryl, optionally comprising one or more heteroatoms and optionally substituted with one or more substituents selected from the group consisting of halogen, hydroxy, C₁-C₆ alkoxy, C₁-C₆ alkylthio, C₁-C₆ acyl, formyl, cyano, C₆-C₁₅ aryloxy and C₆-C₁₅ aryl; and
R₂ is selected from the group consisting of a C₁-C₂₀ alkyl and a C₆-C₃₀ aryl, optionally comprising one or more heteroatoms and optionally substituted with one or more substituents selected from the group consisting of halogen, hydroxy, C₁-C₆ alkoxy, C₁-C₆ alkylthio, C₁-C₆ acyl, formyl, cyano, C₆-C₁₅ aryloxy and C₆-C₁₅ aryl.

2. The copolyamide of claim 1, wherein
R₁ is selected from the group consisting of a C₄-C₁₀ alkyl and a C₆-C₁₂ aryl, optionally substituted with one or more substituents selected from the group consisting of halogen, hydroxy, C₁-C₆ alkoxy, C₁-C₆ alkylthio, C₁-C₆ acyl, formyl, cyano, C₆-C₁₅ aryloxy and C₆-C₁₅ aryl, and/or
R₂ is selected from the group consisting of a C₄-C₁₂ alkyl and a C₆-C₁₂ aryl, optionally comprising one or more heteroatoms.

3. The copolyamide of claim 1, wherein the copolyamide is the condensation product of a mixture comprising from 5 mol. % to 90 mol.% of 4-(aminomethyl)benzoic acid (4-AMBa) or derivative thereof, and at least one dicarboxylic acid component or derivative thereof, and at least one diamine component.

4. The copolyamide of claim 1, wherein the copolyamide is the condensation product of a mixture comprising:
from 5 mol. % to 90 mol. % of 4-(aminomethyl)benzoic acid (4-AMBa) or derivative thereof,
a dicarboxylic acid component selected from the group consisting of adipic acid, azelaic acid, sebacic acid, dodecanedioic, isophthalic acid, terephthalic acid, 2,6-naphthalene dicarboxylic acid, 4,4′-bibenzoic acid, 5-hydroxyisophthalic acid, 5-sulfophthalic acid, and mixture thereof, and
a diamine component selected from the group consisting of 1,4-diaminobutane, 1,5-diamonopentane, 2-methyl-1,5diaminopentane, hexamethylenediamine, 1,9-diaminononane, 2-methyl-1,8-diaminooctoane, 1,10-diaminedecane, H₂N—(CH₂)₃—O—(CH₂)₂—O(CH₂)₃—NH₂, m-xylylene diamine, p-xylylene, 1,3-bis(aminomethyl)cyclohexane and mixture thereof.

5. The copolyamide of claim 1, wherein the copolyamide is the condensation product of a mixture comprising :
from 5 mol. % to 90 mol. % of 4-(aminomethyl)benzoic acid (4-AMBa) or derivative thereof,
4-(aminomethyl)benzoic acid(4-AMBa)—a dicarboxylic acid component selected from the group consisting of adipic acid, sebacic acid, terephthalic acid, isopthalic acid and mixture thereof, and
a diamine component selected from the group consisting of hexamethylenediamine, m-xylylene diamine, 1,3-bis(aminomethyl)cyclohexane, 1,10-decamethylene diamine and mixture thereof

6. The copolyamide of claim 1, wherein the copolyamide is such that : 50%<nₓ<90%.

7. The copolyamide of claim 1, wherein the copolyamide is such that: 5%<nₓ<85%.

8. The copolyamide of claim 1, wherein the copolyamide has a glass transition temperature of at least 100° C., as determined according to ASTM D3418.

9. A copolyamide composition (C), comprising:
at least one copolyamide according to claim 1,
at one least one of components selected from the group consisting of reinforcing agents, tougheners, plasticizers, colorants, pigments, antistatic agents, dyes, lubricants, thermal stabilizers, light stabilizers, flame retardants, nucleating agents and antioxidants.

10. An article comprising the copolyamide of claim 1.

11. Transparent or semi-transparent articles comprising the copolyamide of claim 1.

12. Windows, clear containers for cosmetic products packaging or glass frames and lenses comprising the article of claim 10.

13. A method for manufacturing a three-dimensional (3D) object with an additive manufacturing system, comprising:
providing a part material comprising the copolyamide of claim 1, and
printing layers of the three-dimensional object from the part material.

14. A filament for use in the manufacture of three-dimensional objects comprising the copolyamide of claim 1.

15. The method of claim 13, wherein the additive manufacturing system is an extrusion-based additive manufacturing system.

16. An article comprising the composition (C) of claim 9.

17. Transparent or semi-transparent articles comprising the composition (C) of claim 9.

18. A method for manufacturing a three-dimensional (3D) object with an additive manufacturing system, comprising :
providing a part material comprising the composition (C) of claim 9, and
printing layers of the three-dimensional object from the part material.

19. A filament for use in the manufacture of three-dimensional objects comprising the composition (C) of claim 9.
